(19) United States
(12) Patent Application Publication
(10) Pub. No.: US 2025/0181943 A1
(43) Pub. Date: Jun. 5, 2025

(54) METHOD AND DEVICES OF AN EFFICIENT GAUSSIAN MIXTURE MODEL (GMM) DISTRIBUTION BASED APPROXIMATION OF A DATA SET IN A COMPUTING ENVIRONMENT

(71) Applicants: Mateusz Przyborowski, Elk (PL); Mateusz Wnuk, Legionowo (PL); Jaroslaw Litwin, Warsaw (PL); Maciej Bartoszuk, Warsaw (PL); Andrzej Janusz, Warsaw (PL); Dominik Slezak, Warsaw (PL)

(72) Inventors: Mateusz Przyborowski, Elk (PL); Mateusz Wnuk, Legionowo (PL); Jaroslaw Litwin, Warsaw (PL); Maciej Bartoszuk, Warsaw (PL); Andrzej Janusz, Warsaw (PL); Dominik Slezak, Warsaw (PL)

(21) Appl. No.: 18/524,550

(22) Filed: Nov. 30, 2023

(51) Int. Cl. G06N 7/00

(52) U.S. Cl. CPC G06N 7/00

(57) ABSTRACT

Disclosed are a method and devices of an efficient Gaussian Mixture Model (GMM) distribution based approximation of a data set in a computing environment. In accordance therewith, parameters of constituent Gaussian distributions of the GMM distribution are iteratively derived based on execution of an Expectation-Maximization (EM) algorithm incorporating the data set as an input thereto. The data set is modified by replacing, for each constituent Gaussian distribution of the GMM distribution, numeric values and/or vectors of the numeric values of the data set that differ in magnitude from a center of the each constituent Gaussian distribution by less than a threshold with a mean value of the data set, with a weight of the mean value being indicative of a cardinality thereof within the modified data set. Subsequently, the iterative derivation of the parameters of the constituent Gaussian distributions of the GMM distribution is continued.

### FIELD OF TECHNOLOGY

This disclosure relates generally to big data processing and, more particularly, to a method and/or devices of an efficient Gaussian Mixture Model (GMM) distribution based approximation of a data set in a computing environment.

### BACKGROUND

A computing environment may involve processing large data sets including large volumes of and/or complex data. The computing environment may, for example, be a Machine Learning (ML) environment involving large training data sets. A probabilistic model such as a Gaussian Mixture Model (GMM) may assume that all data points within the large data sets are generated from a mixture of a finite number of Gaussian distributions. The GMM may enable clustering of data points within the large data sets. Further, the GMM may be relatively uninfluenced by outliers within the data points, i.e., data points that are difficult to be classified under clusters. However, computations of parameters (e.g., means) of the Gaussian distributions forming the GMM may be difficult or impossible using analytical methods.

### SUMMARY

Disclosed are a method and/or devices of an efficient Gaussian Mixture Model (GMM) distribution based approximation of a data set in a computing environment.

In one aspect, a method of generating a Gaussian Mixture Model (GMM) distribution that approximates a data set using a processor communicatively coupled to a memory is disclosed. The method includes iteratively deriving parameters of constituent Gaussian distributions of the GMM distribution based on executing an Expectation-Maximization (EM) algorithm on the processor communicatively coupled to the memory, with the EM algorithm incorporating the data set as an input thereinto. The method also includes modifying the data set by replacing, for each constituent Gaussian distribution of the GMM distribution, numeric values and/or vectors of the numeric values of the data set that differ in magnitude from a center of the each constituent Gaussian distribution by less than a threshold with a mean value of the data set, with a weight of the mean value being indicative of a cardinality thereof within the modified data set.

Further, the method includes continuing the iterative derivation of the parameters of the constituent Gaussian distributions of the GMM distribution based on the execution of the EM algorithm that now incorporates the modified data set thereinto along with the weight of the mean value, and reducing a data footprint of the data set through the GMM distribution based on the continued iterative derivation of the parameters of the constituent Gaussian distributions thereof.

In another aspect, a data processing device to generate a GMM distribution that approximates a data set is disclosed. The data processing device includes a memory and a processor communicatively coupled to the memory. The processor executes instructions to iteratively derive parameters of constituent Gaussian distributions of the GMM distribution based on executing an EM algorithm, with the EM algorithm incorporating the data set as an input thereinto. The processor also executes instructions to modify the data set by replacing, for each constituent Gaussian distribution of the GMM distribution, numeric values and/or vectors of the numeric values of the data set that differ in magnitude from a center of the each constituent Gaussian distribution by less than a threshold with a mean value of the data set, with a weight of the mean value being indicative of a cardinality thereof within the modified data set.

Further, the processor executes instructions to continue the iterative derivation of the parameters of the constituent Gaussian distributions of the GMM distribution based on the execution of the EM algorithm that now incorporates the modified data set thereinto along with the weight of the mean value, and reduce a data footprint of the data set through the GMM distribution based on the continued iterative derivation of the parameters of the constituent Gaussian distributions thereof.

In yet another aspect, a data processing device to generate a GMM distribution that approximates a data set is disclosed. The data processing device includes a memory and a processor communicatively coupled to the memory. The processor executes instructions to iteratively derive parameters of constituent Gaussian distributions of the GMM distribution based on executing an EM algorithm, with the EM algorithm incorporating the data set as an input thereinto. The processor also executes instructions to modify the data set by replacing, for each constituent Gaussian distribution of the GMM distribution, numeric values and/or vectors of the numeric values of the data set that differ in magnitude from a center of the each constituent Gaussian distribution by less than a threshold with a mean value of the data set, with a weight of the mean value being indicative of a cardinality thereof within the modified data set.

Further, the processor executes instructions to continue the iterative derivation of the parameters of the constituent Gaussian distributions of the GMM distribution based on the execution of the EM algorithm that now incorporates the modified data set thereinto along with the weight of the mean value, and utilize the generated GMM distribution along with or instead of the data set and/or the modified data set for computation using a Machine Learning (ML) algorithm also executing on the processor.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a computing system, according to one or more embodiments.

FIG. 2 shows a process flow diagram detailing the operations involved in generation of a Gaussian Mixture Model (GMM) distribution from input data to an adaptive Expectation-Maximization (EM) algorithm executing on a data processing device of the computing system of FIG. 1, according to one or more embodiments.

FIG. 3 is a schematic view of determination of a threshold stored in a memory of the data processing device of the computing system of FIG. 1 based on one or more criteria therefor, according to one or more embodiments.

Other features of the present embodiments will be apparent from the accompanying drawings and from the detailed description that follows.

### DETAILED DESCRIPTION

Example embodiments, as described below, may be used to provide a method and/or devices of an efficient Gaussian Mixture Model (GMM) distribution based approximation of a data set in a computing environment. Although the present embodiments have been described with reference to specific example embodiments, it will be evident that various modifications and changes may be made to these embodiments without departing from the broader spirit and scope of the various embodiments.

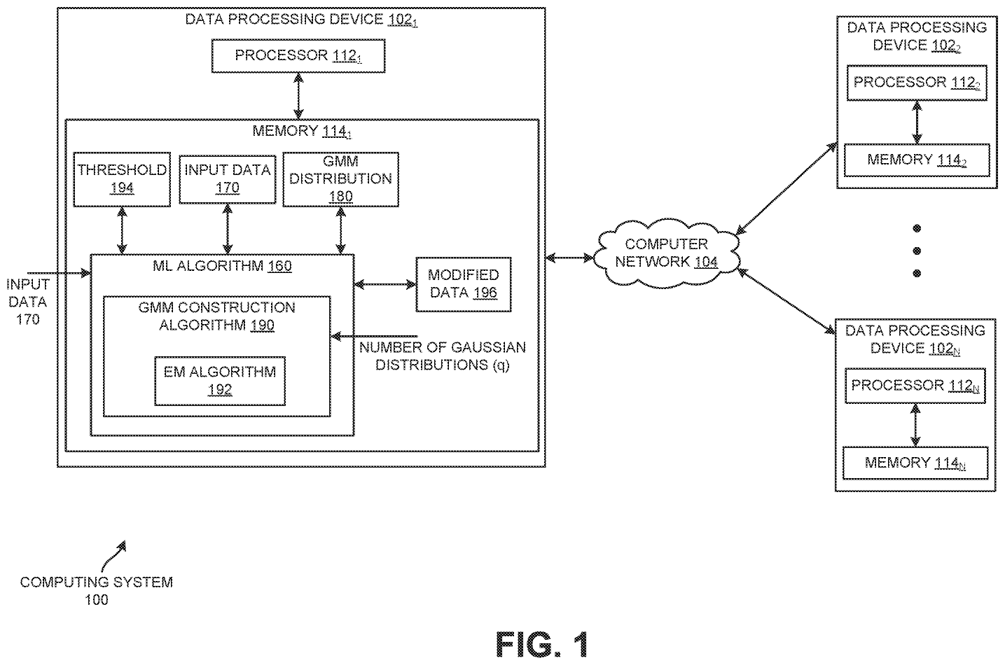

FIG. 1 shows a computing system 100, according to one or more embodiments. In one or more embodiments, computing system 100 may include a number of data processing devices 102_{1-N} communicatively coupled to one another through a computer network 104 (e.g., a Local Area Network (LAN), a Wide Area Network (WAN), the Internet, a short-range network based on Bluetooth®, WiFi® and the like). It should be noted that while exemplary embodiments have been placed within the context of computing system 100, concepts discussed herein may be applicable to a standalone data processing device 102_{1-N} of computing system 100. In one or more embodiments, data processing devices 102_{1-N} may include one or more server(s), one or more client device(s) and/or one or more portable computing devices (e.g., mobile phones, smart devices). In one or more embodiments, data processing devices 102_{1-N} of computing system 100 may constitute a distributed (e.g., across a cloud) network of data processing devices, a cluster of data processing devices and/or a hybrid network of data processing devices. All reasonable variations are within the scope of the exemplary embodiments discussed herein.

As shown in FIG. 1, in one or more embodiments, each data processing device 102_{1-N} may include a processor 112_{1-N} (e.g., a standalone processor, a network/cluster of processors) communicatively coupled to a memory 114_{1-N} (e.g., a volatile and/or a non-volatile memory). For example, data processing device 102₁ may implement a Machine Learning (ML) algorithm 160 therein. It should be noted that ML algorithm 160 may be implemented across more than one data processing device 102_{1-N} of computing system 100. However, ML algorithm 160 has been shown as executing solely on data processing device 102₁ (e.g., stored in memory 114₁ and executing on processor 112₁) merely for the sake of example. In one or more embodiments, ML algorithm 160 itself may include a set of algorithms.

FIG. 1 shows input data 170 to ML algorithm 160, according to one or more embodiments. In one or more embodiments, input data 170 may include data sets that are too large in volume and/or too complex to be handled conventionally. In one or more embodiments, in addition to storage and/or management requirements of input data 170 within computing system 100, useful information and/or insights may also need to be derived from input data 170 depending on the context (e.g., near real-time responses required in some, non-real-time responses in others). In one or more embodiments, a Gaussian Mixture Model (GMM) including Gaussian distribution components may be employed to represent input data 170. In one or more embodiments, GMMs may be employed in many computational areas including but not limited to data analysis and processing, ranging from density estimation, image segmentation and sound recognition to multidimensional clustering and data visualization. Exemplary embodiments discussed herein may be especially applicable to utilization of GMMs to describe the contents of big data sets such as input data 170 and accelerating analytical and Artificial Intelligence (AI)/ML-related computations (e.g., computations implemented through ML algorithm 160) over said big data sets.

In some embodiments, more than one Gaussian distribution may describe the contents of input data 170. Thus, in one or more embodiments, the GMM incorporating these Gaussian distributions may be treated as summaries of input data 170. In one or more embodiments, for a given collection of numeric values and/or vectors of numeric values as input data 170, the GMM (it is to be noted that more than one GMM may also be derivable) may be derived to summarize the distribution of this collection of the numeric values and/or the vectors of the numeric values. “Vectors,” as discussed herein, may be regarded as an object or a data point of input data 170 in tabular form. In one or more embodiments, the distribution (e.g., GMM distribution 180) associated with the derived GMM may be stored along with or instead of input data 170. FIG. 1 shows GMM distribution 180 as being stored along with input data 170 in memory 114₁ for the sake of example.

For example, if input data 170 included 1000 values and may be described using 10 Gaussian components, each of which is described by 3 parameters (mean, standard deviation and weight/amplitude), it may be possible to operate with 30 parameters instead of the 1000 original values. Thus, a 30:1 compression in size and, thereby, significant positive implications for computational speed using ML algorithm 160 (or, another algorithm implemented through data processing device 102₁) may be possible through GMM distribution 180 storage in memory 114₁ instead of input data 170.

In one or more embodiments, very large data sets associated with input data 170 may be replaced with the smaller data points/elements of GMM distribution 180; various analytics and/or AI/ML related computations (e.g., based on ML algorithm 160) may thus be performed against GMM distribution 180 instead of input data 170. Consequently, in one or more embodiments, the analytics and/or AI/ML related computations against GMM distribution 180 may be faster compared to performance thereof against input data 170. In some scenarios, it may be possible to remove input data 170 from computing system 100 completely after generating GMM distribution 180. Here, in one or more embodiments, not only speed of the analytics and/or the AI/ML related computations may be improved but also data footprint(s) may be reduced because GMM distribution 180 may require less space in memory 114₁ than input data 170.

In one or more embodiments, the efficiency and/or the accuracy of generation of GMM distribution 180 from input data 170 to address the abovementioned analytics and/or the AI/ML related computations may be crucial to the improvement of computational speed and/or the data footprint reduction discussed above. Exemplary embodiments discussed herein may provide for improved efficiency and/or accuracy in the generation of GMM distribution 180 from input data 170.

In some embodiments, input data 170 may be low-dimensional (e.g., one-dimensional). Here, in general, in one or more embodiments, input data 170 may take a tabular form with a number of numeric (e.g., integer, float, decimal) columns. In one or more embodiments, these numeric columns may also be regarded as attributes, variables and/or dimensions. In one or more embodiments, considering single columns or small subsets of columns of input data 170, the input to a GMM construction algorithm 190 (e.g., part of ML algorithm 160 in memory 114₁; GMM construction algorithm 190 may also, in some embodiments, be distinct from ML algorithm 160) may be a collection of numeric values over a single attribute or vectors of numeric values for a small set of attributes. For example, the aforementioned numeric values or vectors of numeric values may correspond to different rows in the tabular form of input data 170.

In one or more embodiments, a number of Gaussian distributions that are to be part of GMM distribution 180 may also be specified as a parameter to GMM construction algorithm 190. In one or more embodiments, GMM construction algorithm 190 may determine parameters and/or shapes of the number of Gaussian distributions such that GMM distribution 180 obtained therefrom approximates in a maximally accurate way an empirical distribution computable/computed directly from input data 170. While many algorithms may be possible, exemplary embodiments, as discussed above, provide for efficient and/or accurate generation of GMM distribution 180 using a unique GMM construction algorithm 190.

As seen above, in one or more embodiments, input data 170 may be a collection of numeric values and/or vectors of numeric values. In one or more embodiments, the most common algorithm for a GMM may be an Expectation-Maximization (EM) algorithm, whereby parameters of the Gaussian distributions thereof are updated after estimating probabilities of the observed input data 170 (also called “observations”). In one or more embodiments, viewing input data 170

x={x₁,x₂ . . . xₗ}

as random variables from a mixture of distributions, computations of the means of the distributions involved in a GMM using analytical methods may be difficult or impossible.

Therefore, in one or more embodiments, the EM algorithm may include two operations, viz. expectation and maximization. Assuming that the GMM/GMM distribution 180 includes q components or q Gaussian distributions therein, in one or more embodiments, as part of the expectation operation, for each observation xⱼ∈{x₁, x₂ . . . xₗ}, the probability that xⱼ originates from the i^{th} (i={1, 2 . . . q}) Gaussian distribution may be computed. In one or more embodiments, as part of the maximization operation, for each i={1, 2 . . . q}, parameters μᵢ, Σᵢ and wᵢ (μᵢ may refer to a mean of the i^{th} Gaussian distribution, Σᵢ may refer to a variance of the i^{th} Gaussian distribution for a univariate form thereof or a covariance (e.g., in matrix form) of the i^{th} Gaussian distribution for a multivariate form thereof, and wᵢ may refer to a weight of the i^{th} Gaussian distribution indicative of a probability that input data 170 xⱼ belongs to the i^{th} Gaussian distribution) that maximize an evidence lower bound for all xⱼ given the aforementioned derived probabilities may be found. In some embodiments, initial values for the mean of the i^{th} Gaussian distribution may be obtained through a random guess and/or a heuristic approach such as one involving a k-means (or, q-means) clustering algorithm.

It should be noted that the EM algorithm (e.g., EM algorithm 192) discussed herein may be part of GMM construction algorithm 190 or associated therewith. FIG. 1 shows EM algorithm 192 as part of GMM construction algorithm 190 for the sake of example. In one or more embodiments, in the execution of EM algorithm 192, each iteration thereof may require O (ql) computations. Therefore, in one or more embodiments, with a fixed maximum number of iterations, it may be reasonable to try to decrease the number of observations (l) or reduce the number of elements of the above data set (e.g., input data 170) to which xⱼ belongs as long as convergence of EM algorithm 192 is achieved and maintained. Also, in one or more embodiments, given that the number (q) of components or the number (q) of Gaussian distributions of the GMM/GMM distribution 180 is significantly smaller than the number of observations (l), i.e., l>>q, k-means (or, q-means) clustering algorithm based initialization for μᵢ may usually yield values that are approximately close to a local minimum obtained through EM algorithm 192. In one or more embodiments, as the estimate for μᵢ from the maximization operation discussed above is equal to the mean of all observations ( [symbol] ) weighted by the probabilities of the observations originating from the i^{th} Gaussian distribution of the GMM/GMM distribution 180, i.e., μᵢ= [symbol] wᵢ, in general, observations that are further from the aforementioned estimate for μᵢ thus far may contribute less to the total estimation thereof. Conversely, in one or more embodiments, only observations that are closest to the aforementioned estimate for μᵢ may determine μᵢ.

Also, it should be noted that the abovementioned observation may solely be applicable to μᵢ. In one or more embodiments, the estimation of Σᵢ may operate on centered observations. In one or more embodiments, for the i^{th} Gaussian distribution of the GMM/GMM distribution 180, observations that are close to μᵢ may be expected to be approximately similar to one another. However, in one or more embodiments, in order to describe this approximate similarity, sole reliance on wᵢ may not be enough because wᵢ may be strongly affected by the proximities of centers of other components/Gaussian distributions of the GMM/GMM distribution 180.

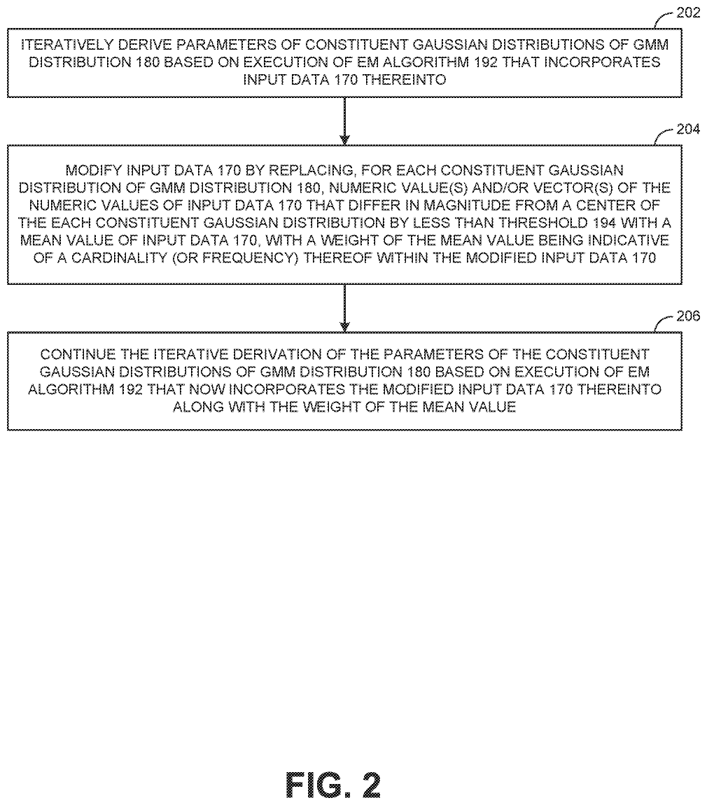

To summarize, in one or more embodiments, in each expectation operation of EM algorithm 192, the whole data set within input data 170 may be used; however, some observations (e.g., after a couple of iterations) may always yield a similar impact on the result. FIG. 2 shows the operations involved in generation of GMM distribution 180 from input data 170 utilizing an adaptive EM algorithm (e.g., EM algorithm 192) that is part of GMM construction algorithm 190, according to one or more embodiments. In one or more embodiments, as discussed above, input data 170 may be a collection of numeric values and/or vectors of numeric values. In one or more embodiments, input data 170 itself may be a subset or a smaller set of data input to ML algorithm 160 executing on data processing device 102₁ and/or received at data processing device 102₁. In one or more embodiments, operation 202 may involve iteratively deriving parameters (e.g., μᵢ, Σᵢ, wᵢ discussed above) of constituent Gaussian distributions (e.g., q Gaussian distributions) of GMM distribution 180 based on execution of EM algorithm 192 that incorporates input data 170 thereinto.

In one or more embodiments, operation 204 may involve modifying input data 170 (e.g., the modified input data 170 is shown as modified data 196 in FIG. 1) by replacing, for each constituent Gaussian distribution of GMM distribution 180, numeric value(s) and/or vector(s) of the numeric values of input data 170 that differ in magnitude from a center of the each constituent Gaussian distribution by less than a threshold value (e.g., threshold 194 shown stored in memory 114₁) with a mean value of input data 170, with a weight of the mean value being indicative of a cardinality (or frequency) thereof within the modified input data 170 (e.g., modified data 196). In one or more embodiments, operation 206 may then involve continuing the iterative derivation of the parameters of the constituent Gaussian distributions of GMM distribution 180 based on execution of EM algorithm 192 that now incorporates the modified input data 170 (e.g., modified data 196) thereinto along with the weight of the mean value.

It should be noted that, in accordance with the operations above, the weights of elements of input data 170 may be uniform at the beginning and that with the replacement of specific element(s) therein with the mean value of input data 170, the weights of the replaced specific element(s) in modified data 196 may increase in accordance with the cardinality/frequency thereof in modified data 196.

In one or more embodiments, input data 170 may be stored along with modified data 196 at one or more or all stages of the iteration. In some other embodiments, input data 170 may be replaced with modified data 196 to reduce a data footprint within data processing device 102₁/computing system 100. In one or more embodiments, the reduced complexity and/or volume of the representation of input data 170 by way of GMM distribution 180 based on execution of EM algorithm 192 may provide for efficient and fast computation with regard to operations associated with ML algorithm 160.

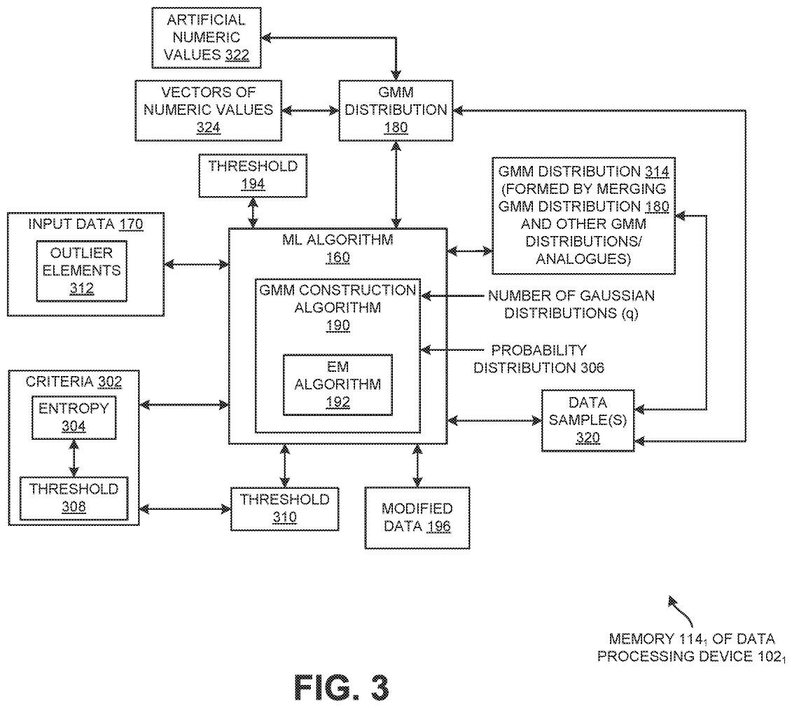

FIG. 3 shows determination of threshold 194 discussed above based on criteria 302 (or, a criterion), according to one or more embodiments. In one or more embodiments, criteria 302 may involve estimation of an entropy 304 of a probability distribution 306 (e.g., utilized by EM algorithm 192/GMM construction algorithm 190) characterizing an extent to which the numeric value(s) and/or the vector(s) of the numeric values of input data 170 may be generated from the each constituent Gaussian distribution discussed above. In one or more embodiments, criteria 302 may involve the estimated entropy 304 being below another threshold (e.g., threshold 308) for determination of threshold 194. Additionally or alternatively, in one or more embodiments, criteria 302 may involve the numeric value(s) and/or the vector(s) of the numeric values of input data 170 being different in magnitude from the center of the each constituent Gaussian distribution by less than a numeric distance (e.g., threshold 194) and from the centers of other constituent Gaussian distributions (or, at least one other constituent Gaussian distribution) of GMM distribution 180 by more than another numeric distance (e.g., threshold 310).

In one or more embodiments, if the numeric value(s) and/or the vector(s) of the numeric values of input data 170 that differ in magnitude from the center of the each constituent Gaussian distribution by less than threshold 194 are the same as one another, a standard deviation thereof equal to 0 may be added immediately (e.g., based on execution of EM algorithm 192/GMM construction algorithm 190 on processor 112₁) to GMM distribution 180, and subsequent phases of the iterative processes using EM algorithm 192 may be performed without the aforementioned numeric value(s) and/or the vector(s) of the numeric values. In one or more embodiments, the identification of the numeric value(s) and/or the vector(s) of the numeric value(s) that are different from the center(s) of one or more constituent Gaussian distribution(s) of GMM distribution 180 and the replacement thereof with the mean value of input data 170/modified data 196 (as applicable) may be repeated.

In one or more embodiments, outlier elements 312 (e.g., one or more numeric values and/or one or more vectors of numeric values; outlier elements 312 may be numeric value(s) and/or vector(s) of numeric value(s) that are far off from, say, [symbol] ) may be identified in input data 170 in accordance with the execution of EM algorithm 192. In one or more embodiments, the identification of outlier elements 312 may be accompanied by adding said identified outlier elements 312 to GMM distribution 180 with standard deviations thereof equal to 0 and continuing the iterative processes of EM algorithm 192 after removing outlier elements 312 from modified data 196.

In one or more embodiments, as shown in FIG. 1 and FIG. 3 and as discussed above, the number of constituent Gaussian distributions of GMM distribution 180, i.e., q, may be specified as an input parameter to EM algorithm 192/GMM construction algorithm 190. In one or more embodiments, in scenarios where GMM distribution 180 with q constituent Gaussian distributions does not approximate input data 170 well (e.g., inadequately based on predefined/dynamically defined criteria 302, other predefined/dynamically defined tests implemented in EM algorithm 192/EMM construction algorithm 190), EM algorithm 192/EMM construction algorithm 190 may work with less than q constituent Gaussian distributions to generate GMM distribution 180 that does approximate input data 170 well.

In one or more embodiments, as discussed above, GMM distribution 180 generated may replace input data 170/modified data 196 in data processing device 102₁/computing system 100 and may be made available as an approximate model of input data 170 for any operation performed through data processing device 102₁/computing system 100 (e.g., based on execution of ML algorithm 160). In one or more other embodiments, GMM distribution 180 may be added as metadata to memory 114₁ and may be available together with input data 170 (and/or modified data 196) for any operation performed through data processing device 102₁/computing system 100.

In one or more embodiments, the numeric value(s) of input data 170 discussed above may be taken by consecutive rows of a data column of a data table that constitutes or at least is part of input data 170. In one or more embodiments, the vectors of numeric value(s) of input data 170 may be taken by consecutive rows of the data table or another data table for at least a subset of the data columns thereof. Again, as discussed above, in one or more embodiments, input data 170 itself may be part of an even larger data set; here, input data 170 may be a smaller set of the even larger data set. Here, in one or more embodiments, GMM distribution 180 and analogues (e.g., GMM distributions analogous to GMM distribution 180) thereof may be constructed and stored for each smaller sets of the even larger data set including input data 170. In one or more embodiments, GMM distribution 180 and one or more analogues thereof may be merged together to form another GMM distribution 314 to facilitate operations requiring a data set larger than input data 170.

In one or more embodiments, the abovementioned merger may be performed based on modification of EM algorithm 192 to account for all parameters of GMM distribution 180 and the one or more analogues thereof. In one or more embodiments, the splitting of the even larger data set discussed above into smaller sets including input data 170 discussed above may be optimized in accordance with maximizing approximation of GMM distribution 180 and the analogues thereof to the corresponding smaller sets.

In one or more embodiments, input data 170 may take the form of an output of transformation of a complex object into the numeric values and/or the vectors of numeric values discussed above. In one or more embodiments, the complex object may be an image, video data, text and/or a time series data of sensor measurements. In one or more embodiments, the transformation may be a feature extraction operation, an embedding operation and/or an internal layer of an autoencoder (e.g., a neural network). It should be noted that the complex object and/or the output of the transformation may be stored along with GMM distribution 180 and/or the analogues discussed above. Alternatively, in some embodiments, GMM distribution 180 and/or the analogues alone may be stored and not input data 170.

In one or more embodiments, input data 170, GMM distribution 180 and/or the analogues thereof may be utilized by ML algorithm 160 in learning an ML model to be implemented (or implemented) therethrough, in preparing a business intelligence report and/or in data clustering. In one or more embodiments, the aforementioned utilization may generate one or more data sample(s) (e.g., data sample(s) 320) based on selecting a subset of the smaller sets of the even larger data set discussed above in accordance with finding GMM distribution 314 that is representative of GMM distribution 180 and analogues thereof of all the smaller sets followed by generating artificial numeric values (e.g., artificial numeric values 322) and/or vectors of numeric values (e.g., artificial vectors of numeric values 324) based on GMM distribution 180 and the analogues thereof and/or selecting actual numeric values and/or vectors of numeric values belonging to the selected smaller sets.

In one or more embodiments, the choice of GMM distribution 314 representative of GMM distribution 180 and analogues thereof may be based on analysis of distances between GMM distribution 180 and one or more analogues thereof and/or between the analogues. In one or more embodiments, the aforementioned distances may be based on a Wasserstein distance and/or a Kullback-Leibler divergence. In one or more embodiments, a subset of complex objects in data associated with computing system 100 that is most similar to a complex object discussed above within input data 170 may be found based on execution of EM algorithm 192/GMM construction algorithm 190/ML algorithm 160 in accordance with transforming the complex object into representation thereof in terms of numeric values and probabilistic similarity based analysis of the representation against GMM distribution 180 and/or analogues thereof to find the smaller sets of the even larger data set discussed above.

In one or more embodiments, pairs of data columns belonging to different data tables of input data 170 may be determined to have GMM representations (e.g., GMM distribution 180 and an analogue thereof) closest to one another in accordance with the discussion above. Again, in one or more embodiments, the closeness of the aforementioned pairs may be measured based on a Wasserstein distance and/or a Kullback-Leibler divergence. With regard to two or more source(s) of complex objects being represented in input data 170, in one or more embodiments, GMM representations (e.g., GMM distribution 180 and one or more analogues thereof) may be compared to one another to verify semantic similarity of the complex objects coming from the two or more source(s). It should be noted that the applications of GMM distribution 180, EM algorithm 192, EMM construction algorithm 190 and/or ML algorithm 160 may not be limited to the examples mentioned above.

Last but not the least, drawing elements of FIGS. 1 and 3 other than data processing devices 102_{1-N} and computing network 104 may be executable through processor 112₁, results of processing therethrough, inputs thereto and/or stored in memory 114₁, even if FIGS. 1 and 3 do not show one or more of the aforementioned explicitly. All reasonable variations are within the scope of the exemplary embodiments discussed herein.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., computing system 100, data processing device 102₁), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of generating a Gaussian Mixture Model (GMM) distribution that approximates a data set using a processor communicatively coupled to a memory, comprising:
iteratively deriving parameters of constituent Gaussian distributions of the GMM distribution based on executing an Expectation-Maximization (EM) algorithm on the processor communicatively coupled to the memory, the EM algorithm incorporating the data set as an input thereinto;
modifying the data set by replacing, for each constituent Gaussian distribution of the GMM distribution, at least one of: numeric values and vectors of the numeric values of the data set that differ in magnitude from a center of the each constituent Gaussian distribution by less than a threshold with a mean value of the data set, with a weight of the mean value being indicative of a cardinality thereof within the modified data set;
continuing the iterative derivation of the parameters of the constituent Gaussian distributions of the GMM distribution based on the execution of the EM algorithm that now incorporates the modified data set thereinto along with the weight of the mean value; and
reducing a data footprint of the data set through the GMM distribution based on the continued iterative derivation of the parameters of the constituent Gaussian distributions thereof.

2. The method of claim 1, comprising determining the threshold in accordance with at least one of:
estimating an entropy of a probability distribution characterizing an extent to which the at least one of: the numeric values and the vectors of the numeric values are generated from the each constituent Gaussian distribution; and
the at least one of: the numeric values and the vectors of the numeric values being different in magnitude from the center of the each constituent Gaussian distribution by less than a numeric distance and from another center of at least one other constituent Gaussian distribution of the GMM distribution by more than another numeric distance.

3. The method of claim 1, wherein in accordance with the at least one of: the numeric values and the vectors of the numeric values that differ in magnitude from the center of the each constituent Gaussian distribution by less than the threshold being the same as one another, the method further comprises:
adding a standard deviation of the same at least one of: the numeric values and the vectors of the numeric values as equal to 0 to the GMM distribution; and
performing a subsequent phase of the continued iterative derivation of the parameters of the constituent Gaussian distributions without the same at least one of: the numeric values and the vectors of the numeric values.

4. The method of claim 1, further comprising:
identifying at least one outlier element in the data set in accordance with the execution of the EM algorithm;
adding the identified at least one outlier element to the GMM distribution with a standard deviation thereof equal to 0; and
continuing an iterative process of the EM algorithm after removing the at least one outlier element from the modified data set.

5. The method of claim 1, further comprising:
specifying a first number of the constituent Gaussian distributions of the GMM distribution as an input parameter to the EM algorithm; and
the EM algorithm working with a second number of the constituent Gaussian distributions of the GMM distribution that is less than the first number of the constituent Gaussian distributions in accordance with the GMM distribution with the first number of the constituent Gaussian distributions inadequately approximating the data set.

6. The method of claim 1, further comprising one of:
replacing at least one of: the data set and the modified data set with the GMM distribution for an operation to be performed using the processor communicatively coupled to the memory; and
adding the GMM distribution as metadata to the memory for availability thereof together with the at least one of: the data set and the modified data set for the operation to be performed using the processor communicatively coupled to the memory.

7. The method of claim 1, comprising at least one of:
the numeric values of the data set being taken by consecutive rows of a data column of a data table that one of: constitutes and at least is part of the data set; and
the vectors of the numeric values of the data set being taken by consecutive rows of one of: the data table and another data table for at least a subset of data columns thereof.

8. The method of claim 1, further comprising at least one of:
the data set being a smaller set of a larger data set;
constructing a plurality of GMM distributions comprising the generated GMM distribution for a corresponding plurality of smaller sets of the larger data set comprising the data set; and
merging the GMM distributions of the constructed plurality of GMM distributions together to form another GMM distribution.

9. The method of claim 8, further comprising at least one of:
merging the GMM distributions of the constructed plurality of GMM distributions together in accordance with modification of the EM algorithm to account for all parameters of the constructed plurality of GMM distributions; and
optimizing splitting of the larger data set into the plurality of smaller sets comprising the data set in accordance with maximizing approximation of the constructed plurality of GMM distributions to the corresponding plurality of smaller sets.

10. The method of claim 8, further comprising at least one of:
the data set taking a form of an output of transformation of a complex object;
the complex object being at least one of: an image, video data, text and a time series data of sensor measurements;
the transformation of the complex object being at least one of: a feature extraction operation, an embedding operation and an internal layer of an autoencoder;
storing at least one of: the complex object and the output of the transformation in the memory along with the constructed plurality of GMM distributions; and
storing the constructed plurality of GMM distributions without storing the at least one of: the complex object and the output of the transformation.

11. The method of claim 1, further comprising the processor utilizing at least one of: the data set and the GMM distribution in at least one of: learning a Machine Learning (ML) model, preparing an intelligence report and data clustering.

12. The method of claim 8, further comprising at least one of:
the processor utilizing at least one of: the data set and the constructed plurality of GMM distributions in at least one of: learning an ML model, preparing a business intelligence report and data clustering;
generating at least one data sample based on selecting a subset of the plurality of smaller sets in accordance with finding the another GMM distribution that is representative of the constructed plurality of GMM distributions followed by generating an artificial at least one of: at least one numeric value and at least one vector of numeric values based on the constructed plurality of GMM distributions;
choosing the another GMM distribution as representative of the constructed plurality of GMM distributions based on analysis of distances between the GMM distributions of the constructed plurality of GMM distributions; and
the analysis of the distances between the GMM distributions of the constructed plurality of GMM distributions being based on at least one of: a Wasserstein distance and a Kullback-Leibler divergence.

13. The method of claim 10, further comprising finding a subset of complex objects in data associated with the processor communicatively coupled to the memory that is most similar to the complex object based on execution of the EM algorithm in accordance with the transformation of the complex object into representational numeric values thereof and probabilistic similarity based analysis of the representational numeric values against the constructed plurality of GMM distributions to find the plurality of smaller sets.

14. The method of claim 8, further comprising at least one of:
determining that pairs of data columns belonging to different data tables of the data set have corresponding GMM representations thereof in the constructed plurality of GMM distributions closest to one another; and
measuring closeness of the corresponding GMM representations based on at least one of: a Wasserstein distance and a Kullback-Leibler divergence.

15. A data processing device to generate a GMM distribution that approximates a data set, comprising:
a memory; and
a processor communicatively coupled to the memory, the processor executing instructions stored in the memory to:
iteratively derive parameters of constituent Gaussian distributions of the GMM distribution based on executing an EM algorithm, the EM algorithm incorporating the data set as an input thereinto,
modify the data set by replacing, for each constituent Gaussian distribution of the GMM distribution, at least one of: numeric values and vectors of the numeric values of the data set that differ in magnitude from a center of the each constituent Gaussian distribution by less than a threshold with a mean value of the data set, with a weight of the mean value being indicative of a cardinality thereof within the modified data set,
continue the iterative derivation of the parameters of the constituent Gaussian distributions of the GMM distribution based on the execution of the EM algorithm that now incorporates the modified data set thereinto along with the weight of the mean value, and
reduce a data footprint of the data set through the GMM distribution based on the continued iterative derivation of the parameters of the constituent Gaussian distributions thereof.

16. The data processing device of claim 15, wherein the processor executes instructions to determine the threshold in accordance with at least one of:
estimating an entropy of a probability distribution characterizing an extent to which the at least one of: the numeric values and the vectors of the numeric values are generated from the each constituent Gaussian distribution, and
the at least one of: the numeric values and the vectors of the numeric values being different in magnitude from the center of the each constituent Gaussian distribution by less than a numeric distance and from another center of at least one other constituent Gaussian distribution of the GMM distribution by more than another numeric distance.

17. The data processing device of claim 15, wherein the processor executes instructions to one of:
replace at least one of: the data set and the modified data set with the GMM distribution for an operation to be performed using the processor, and
add the GMM distribution as metadata to the memory for availability thereof together with the at least one of: the data set and the modified data set for the operation to be performed using the processor.

18. A data processing device to generate a GMM distribution that approximates a data set, comprising:
a memory; and
a processor communicatively coupled to the memory, the processor executing instructions stored in the memory to:
iteratively derive parameters of constituent Gaussian distributions of the GMM distribution based on executing an EM algorithm, the EM algorithm incorporating the data set as an input thereinto,
modify the data set by replacing, for each constituent Gaussian distribution of the GMM distribution, at least one of: numeric values and vectors of the numeric values of the data set that differ in magnitude from a center of the each constituent Gaussian distribution by less than a threshold with a mean value of the data set, with a weight of the mean value being indicative of a cardinality thereof within the modified data set,
continue the iterative derivation of the parameters of the constituent Gaussian distributions of the GMM distribution based on the execution of the EM algorithm that now incorporates the modified data set thereinto along with the weight of the mean value, and
utilize the generated GMM distribution one of: along with and instead of at least one of: the data set and the modified data set for computation using a Machine Learning (ML) algorithm also executing on the processor.

19. The data processing device of claim 18, wherein the processor executes instructions to determine the threshold in accordance with at least one of:
estimating an entropy of a probability distribution characterizing an extent to which the at least one of: the numeric values and the vectors of the numeric values are generated from the each constituent Gaussian distribution, and
the at least one of: the numeric values and the vectors of the numeric values being different in magnitude from the center of the each constituent Gaussian distribution by less than a numeric distance and from another center of at least one other constituent Gaussian distribution of the GMM distribution by more than another numeric distance.

20. The data processing device of claim 18, wherein the processor executes instructions to reduce a data footprint of the data set through the GMM distribution based on the continued iterative derivation of the parameters of the constituent Gaussian distributions thereof.
